(19) United States
(12) Patent Application Publication
(10) Pub. No.: US 2008/0008429 A1
(43) Pub. Date: Jan. 10, 2008

(54) Receptacle type optical apparatus

(76) Inventors: Futoshi Endou, Yokohama (JP); Tadashi Hatano, Yokohama (JP); Satoshi Motohiro, Yokohama (JP); Hiroyoshi Ishii, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/699,563

(22) Filed: Jan. 30, 2007

(30) Foreign Application Priority Data
Jul. 5, 2006 (JP) 2006-185290

(51) Int. Cl. G02B 6/36

(52) U.S. Cl. 385/93

(57) ABSTRACT

A receptacle type optical apparatus is provided that prevents occurrence of misalignment in coupling optical waveguides. The receptacle type optical apparatus includes an optical device module having a light-emitting device and a light-receiving device, and an enclosure that stores the optical device module, the receptacle type optical apparatus allowing a part of an optical connector to be inserted inside the enclosure and establishing connection with the optical connector. An inner spatial area is formed in the enclosure that allows the part of the optical connector and the optical device module to be swingable with respect to a predetermined position in the optical device module. Furthermore, a support member is provided to swingably support the part of the optical connector and the optical device module integrally at the predetermined position. Accordingly, the receptacle type optical apparatus allows the optical connector and the optical device module to swing integrally, thereby preventing occurrence of misalignment in coupling optical waveguides.

This application relates to and claims priority from Japanese Patent Application No. 2006-185290, filed on Jul. 5, 2006, the entire disclosure of which is incorporated herein by reference.

### BACKGROUND OF THE INVENTION

1. Field of the Invention

The present invention relates to a receptacle type optical apparatus applied to an optical communication system and having a receptacle structure to and from which an optical connector is attachable and detachable. More particularly, it relates to a technique to suppress an optical connection loss.

2. Description of the Related Art

In recent years, attention is being given to various optical communication systems utilizing optical transmission techniques, and there is a rapid shift to optical networks. A receptacle type optical apparatus that that can fit an optical connector in an attachable and detachable manner, that is small-sized and versatile, and that has good operability is recently gaining in importance. However, though the receptacle type optical apparatus is good in operability, there is a problem in that a misalignment may easily occur in coupling between an optical waveguide of an optical device module that is provided with a light emitting device, a light receiving device, and the like, and an optical waveguide of an optical connector, such misalignment being caused by self-weight of an optical fiber cord and a lateral load by a tensile force against the cord.

For example, Japanese Patent Laid-Open Publication No. 2005-215084 (hereinafter, referred to as “Patent Document 1”) discloses a technique to reduce a tendency for misalignment in coupling between an optical waveguide of the optical device module and an optical waveguide of the optical connector. More specifically, an elastic member is placed around a sleeve to hold the coupling portion, in order to suppress deformation of the sleeve that is prone to occur in attaching or detaching the optical connector, or the like, whereby the misalignment between the optical waveguides in coupling is prevented.

### SUMMARY OF THE INVENTION

However, even if the deformation of the sleeve is limited by placing the elastic member around the sleeve, the deformation of the sleeve cannot be suppressed completely, and there is a possibility that misalignment may occur in coupling of the optical waveguides.

An object of the present invention is to provide a receptacle type optical apparatus that allows a part of an optical connector to fit therein so as to be attachable and detachable, and that prevents occurrence of misalignment in coupling between an optical waveguide of the optical device module, and an optical waveguide of the optical connector.

In order to address the problem above, the receptacle type optical apparatus according to an aspect of the present invention is provided with an optical device module, having at least either one of a light emitting device and a light receiving device, and an enclosure to store the optical device module. The receptacle type optical apparatus allows a part of an optical connector to be inserted into the interior of the enclosure to connect the optical connector thereto, wherein an inner spatial area is formed in the enclosure so that the part of the optical connector and the optical device module are swingable therein, with respect to a predetermined position of the optical device module, and a support member is provided to support the part of the optical connector and the optical device module integrally so that they are swingable at the predetermined position.

Hereinafter, specific embodiments of the present invention will be explained. The configurations described below are flexible and include all possible combinations; any of combinations thereof are included within the scope of the present invention. In other words, examples obtained by appropriately removing a partial configuration from the embodiment explained below may form an alternative example of the present invention. It is to be noted that any one of the configurations concretely described below is just one specific example among more generic examples that are assumed to be functionally identical.

According to the receptacle type optical apparatus according to the present invention, it is possible to fit a part of an optical connector therein so that it is attachable and detachable, and the optical connector and the optical device module are swung integrally, whereby occurrence of misalignment in coupling between an optical waveguide of the optical device module and an optical waveguide of the optical connector can be prevented.

### BRIEF DESCRIPTION OF DRAWINGS

FIG. 1 is a cross sectional view that is taken along a plane with respect to which the receptacle type optical apparatus relating to an embodiment of the present invention is symmetrical;

FIG. 2 is a cross sectional view that is taken along a plane with respect to which the receptacle type optical apparatus, to which an optical connector is connected, is symmetrical; and

FIGS. 3A to 3C are cross sectional views that are taken perpendicularly to a central axis of a support member relating to an embodiment of the present invention.

### DETAILED DESCRIPTION OF THE INVENTION

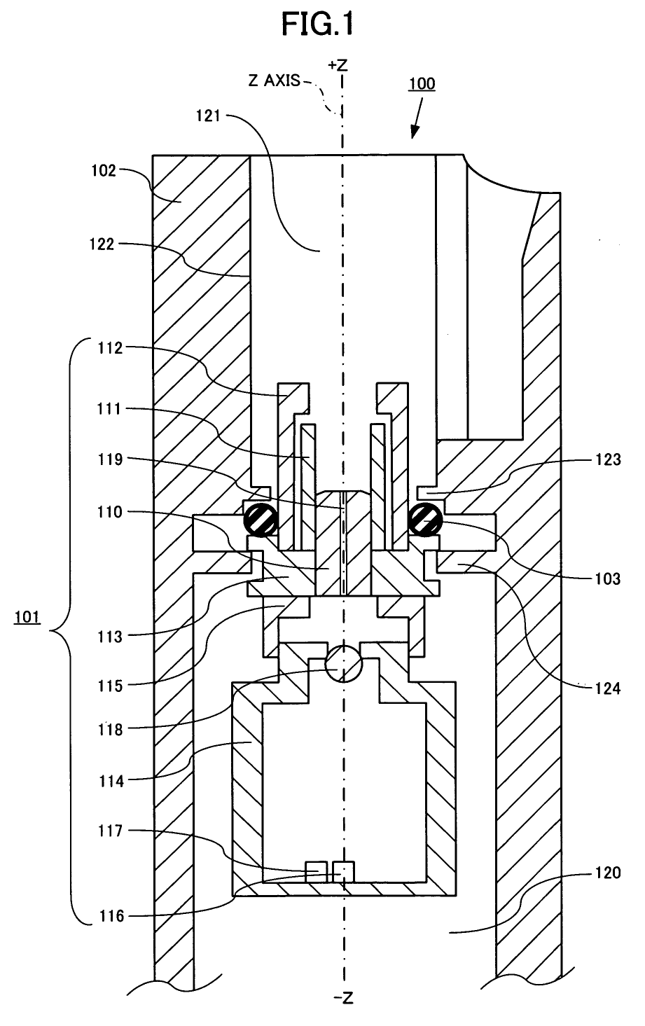

Hereinafter, preferred embodiments of the present invention will be explained with reference to the accompanying drawings. FIG. 1 is a schematic cross sectional view sectioned along a plane with respect to which the receptacle type optical apparatus 100 is almost symmetrical, thereby showing the interior of the receptacle type optical apparatus 100 according to an embodiment of the present invention. In FIG. 1, the central axis is indicated by a short and long dashed line, and it is hereinafter referred to as “Z-axis”. In addition, the direction from which the optical connector is inserted along the Z-axis is taken as “+Z”, and the opposite direction is taken as “−Z”. The optical connector will be described later.

As shown in the cross sectional view in FIG. 1, the receptacle type optical apparatus 100 includes an optical device module 101 having a component to convert an electrical signal to an optical signal and a component to convert an optical signal to an electrical signal, an enclosure 102 to store the optical device module 101, and a support member 103 that supports the optical device module 101 at a predetermined position of the enclosure 102, and the like. Each component constituting the optical device module 101 (ferrule 110, sleeve 111, and the like) are solidly bonded to one another, with an adhesive agent or the like. The optical device module 101 as described above is supported at a predetermined position by the support member 103 that is placed at a predetermined position in the enclosure 102. The optical device module 101 swings using the support member 103 as a support point.

The optical device module 101 includes the ferrule 110 that forms an optical waveguide 119, the sleeve 111 that holds the ferrule 110 and forms a coupling portion to establish connection with an optical connector, and a sleeve cover 112 that prevents the sleeve 111 from falling off in the +Z direction. The optical device module 101 further includes a holder 113 that holds the ferrule 110, the sleeve 111, and the like, a body tube 114 that stores optical system components and the like, and an adapter 115 that connects the holder 113 and the body tube 114. The optical device module 101 further includes, in the interior of the body tube 114, a light emitting device 116 that emits light, a light receiving device 117 that receives light, a lens 118 that gathers the emitted light from the light emitting device 116 into a central part of one end face of the ferrule 110, and also gathers emitted light from the optical waveguide 119 to the position of the light receiving device 117.

The ferrule 110 is made of a ceramic material such as zirconia and alumina, processed into a cylinder having a rotationally symmetric shape about the Z-axis, and the optical waveguide 119 is formed in the interior of the cylinder. The optical waveguide 119 is formed by an optical fiber made of silica glass, or the like, for instance. Light (a signal) for data communication passes through the optical waveguide 119 (optical fiber). The ferrule 110 is processed to have an outer diameter of approximately 1.25 mm. The outer diameter of the optical waveguide 119 (optical fiber) is approximately 10 μm. In addition, one end face of the ferrule 110 is subjected to an abrasive processing to make a spherical shape, so that a ferrule of the optical connector (the ferrule for optical connector 201) described below can be firmly attached thereto with reliability.

For example, the sleeve 111 is made of a ceramic material, for instance, and it is a split sleeve made by slit-processing, by subjecting a cylinder having a rotationally symmetric shape about the Z-axis. The inner diameter of the sleeve 111 is designed to be approximately equal to the outer diameter of the ferrule 110. Accordingly, the sleeve 111 and the ferrule 110 are firmly attached to each other, thereby forming a coupling portion that allows a tip of the optical connector to be inserted.

The sleeve cover 112 is made of a stainless steel material, for instance, and it is a component that is machined as a cylinder having a rotationally symmetric shape about the Z-axis. The sleeve cover 112 covers the sleeve 111 that is exposed, and prevents the sleeve 111 from falling off in the +Z direction.

The holder 113 is made of a stainless steel material, for instance, and it is a component that is machined as a cylinder having a rotationally symmetric shape about the Z-axis. One end face of the holder 113 is processed into a concave shape, and stores the ferrule 110, the sleeve 111, and the sleeve cover 112 in the concave shape, and holds them. The holder 113 is further provided with a groove on the outer periphery on the side facing the enclosure 102, so that the optical device module 101 is allowed to stay approximately at a predetermined position in the Z-axis.

The body tube 114 is made of a metallic material, for instance, and it is a component that is machined as a cylinder having a rotationally symmetric shape about the Z-axis. The body tube 114 has a spatial area inside and stores therein the optical system components such as the light-emitting device 116 and the light-receiving device 117. Furthermore, the body tube 114 has an opening that is capable of embedding the lens 118 described below, at one end facing in the +Z direction.

The adapter 115 is made of a stainless steel material, for instance, and joins the holder 113 and the body tube 114.

The light-emitting device 116 is a light emission type laser having a light emitting plane and the like, for instance, and emits light (a signal) for data communication in the +Z direction.

The light-receiving device 117 receives incident light inputted via the lens 118 described below, and generates an electrical signal responding to the intensity of the received light.

The lens 118 is embedded in the opening provided on one end face of the body tube 114, and it airtightly seals the spatial area inside the body tube 114. The lens 118 is made of a silicon glass material, and the like. The lens 118 gathers the light emitted from the light emitting device 116 on the center of the end of the ferrule 110 facing the −Z direction. The lens 118 further gathers the light emitted from the ferrule 110 on the position of the light-receiving device 117. On this occasion, a method of gathering the light on a desired position is arbitrarily decided. For example, the −Z side end face of the ferrule 110 may be polished so that the end face is positioned obliquely with respect to a plane that is perpendicular to the Z-axis. Alternatively, a reflecting mirror or the like may be employed.

The components constituting the optical device module 101 as described above are strongly bonded together, or are bonded with an adhesive agent or the like. Accordingly, when a force is applied to a part of the optical device module 101, the optical device module is displaced in an integral manner.

The enclosure 102 is made of a metallic material such as aluminum or a rigid plastic such as polycarbonate, for instance, and has a first inner spatial area 120 that stores the body tube 114 of the optical device module 101. The enclosure 102 further includes a second inner spatial area 121 in which a part of the optical connector is inserted in the direction from +Z to −Z.

The first inner spatial area 120 is a space that may prevent the body tube 114 from being brought into contact with the enclosure 102, even when the optical device module 101 is inclined a few degrees (e.g., two or three degrees) with respect to the Z-axis. This configuration enables the optical device module 101 to swing without contact between the body tube 114 and the enclosure 102, when a force is applied to the optical device module 101.

As shown FIG. 1, the enclosure 102 is provided with a first flange 123 that projects towards a direction approaching the Z-axis from the inner wall 122 forming the second inner spatial area 121, so that movement of the support member 103 described below in the Z-axis direction is limited to an expected range. The enclosure 102 is further provided with a second flange 124 that projects in the Z-axis direction from the inner wall 122 forming the second inner spatial area 121, so that the optical device module 101 stays approximately at a predetermined position in the Z-axis direction. The second flange 124 is placed in the groove of the holder 113. With the configuration above, the optical device module 101 is not able to move in the Z-axis direction from a position around the second flange 124.

The support member 103 is placed between the first inner spatial area 120 and the second inner spatial area 121 of the enclosure 102. Also the support member 103 supports the optical device module 101. An O-ring is employed as the support member 103, for instance. The support member 103 is made of an elastic material, such as silicon rubber, for instance. The support member 103 is placed so as to be sandwiched between the enclosure 102 and the optical device module 101, in a direction perpendicular to the Z-axis. The support member 103 is placed so as to be sandwiched between the aforementioned first flange 123 of the enclosure 102 and the holder 113 in the Z-axis direction.

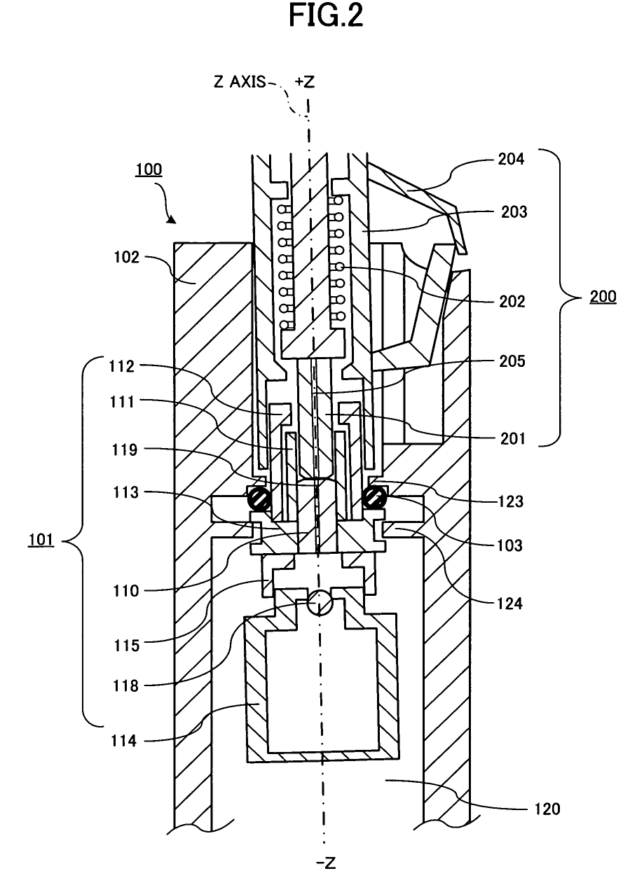

Next, with reference to the cross sectional view as shown in FIG. 2, a case will be explained in which an optical connector 200 is connected to the receptacle type optical apparatus 100.

As shown in FIG. 2, a part of the optical connector 200 is inserted into the second inner spatial area 121 in the enclosure 102 of the receptacle type optical apparatus 100. Here, the part of the optical connector 200 includes at least a component (ferrule for optical connector 201 described below) which forms an optical waveguide. For example, an LC type optical connector provided with a push-pull mechanism is used as the optical connector 200. When a part of a standardized LC type optical connector 200 is inserted into the second inner spatial area 121 and is stressed, the optical connector 200 is inclined by a few degrees (for example, around two degrees) with respect to the Z-axis. As described above, since the optical device module 101 that is connected to the optical connector 200 has a swingable structure, the optical device module 101 is also inclined following the optical connector 200. With this configuration, a linear connection between the optical waveguide 119 (optical fiber) of the optical device module 101 and the optical waveguide for an optical connector 205 (optical fiber) of the optical connector 200 is maintained. The optical waveguide for the optical connector 205 (optical fiber) of the optical connector 200 will be explained below.

The optical connector 200 includes the ferrule for an optical connector 201 having the optical waveguide for the optical connector 205 (optical fiber), and a spring 202 that presses the ferrule for the optical connector 201 in the −Z direction, being crimped to the ferrule 201. The optical connector 200 further includes an optical connector cover 203 to protect the interior of the optical connector 200, a knob 204 that implements a push-pull mechanism to facilitate an operation for attaching or detaching the optical connector, and the like. Here, the optical connector cover 203 and the knob 204 are made of a rigid plastic material such as polycarbonate, for instance.

The ferrule for optical connector 201 is made of ceramic material such as zirconia and alumina, and it is processed into a cylinder having a rotationally symmetric shape about the Z-axis, and forms the optical waveguide for the optical connector 205 in the interior of the cylinder. The optical waveguide for the optical connector 205 is formed by inserting an optical fiber made of silicon glass, or the like, for instance. Light (a signal) for data communication passes through the optical waveguide for the optical connector 205 (optical fiber). The outer diameter of the ferrule for the optical connector 201 is processed to have a dimension of around 1.25 mm. The outside diameter of the optical waveguide for the optical connector 205 (optical fiber) is around 10 μm. In addition, one end face of the ferrule for the optical connector 201 is subjected to an abrasive processing to make a spherical shape, so as to allow the ferrule 110 of the receptacle type optical apparatus 100 to be firmly attached thereto with reliability. The outer diameter of the ferrule for the optical connector 201 is designed to be approximately equal to the inner diameter of the sleeve 111. With the configuration above, when the optical connector 200 is attached to or detached from the receptacle type optical apparatus 100, an appropriate friction is generated between the ferrule for the optical connector 201 and the sleeve 111. Since the outer diameter of the ferrule for the optical connector 201 is approximately equal to the outer diameter of the ferrule 110, the optical waveguide for the optical connector 205 (optical fiber) is aligned with the optical waveguide 119 (optical fiber) formed in the ferrule 110 on a plane perpendicular to the Z-axis. The ferrule for the optical connector 201 and the ferrule 110 are connected along the inner wall of the sleeve 111. Therefore, the optical waveguide 119 (optical fiber) of the optical device module 101 and the optical waveguide for the optical connector 205 (optical fiber) are linearly connected.

The spring 202 presses the ferrule for the optical connector 201 in the −Z direction, and is a general-use spring that allows the ferrule 201 to be firmly attached to the ferrule 110 with reliability.

In the receptacle type optical apparatus 100 to which the optical connector 202 having the above configuration is pressed and connected thereto, the support member 103 supports the optical device module 101 at one point in the Z-axis direction, and the support member 103 is further provided with elasticity. Accordingly, the optical device module 101 is allowed to move in a Z-axis direction and also in a direction perpendicular to the Z-axis, within a range of elasticity of the support member 103. Furthermore, the optical device module 101 is rendered swingable using the support member 103 as a supporting point. On this occasion, the optical device module 101 that has one part of the optical connector 200 inserted is moved and swung so as to be integral with the optical connector 200. This indicates that a force applied to the optical connector 200 is converted into a force to integrally move and swing the optical device module 101 and the optical connector 200. With this configuration, when a force is applied to the optical connector 200, resistance from the optical device module 101 against the ferrule for optical connector 201 is not generated. Therefore, misalignment between the optical waveguide for the optical connector 205 formed in the ferrule for the optical connector 201 and the optical waveguide 119 formed in the ferrule 110 never occurs. In other words, the linear connection between the optical fiber of the optical device module 101 and the optical fiber of the optical connector 200 is maintained. Accordingly, an optical connection loss may not be generated. This configuration may further prevent a breakage of the ferrule for the optical connector 201, the sleeve 111, and the like, at the coupling portion.

It is to be noted that the present invention is not limited to the embodiment above and various modifications and applications are available.

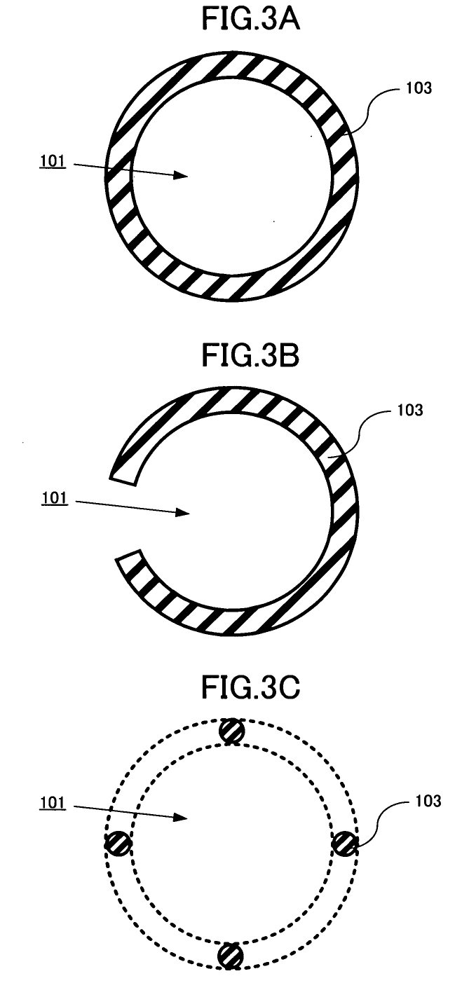

For example, in the embodiment above, the support member 103 that supports the optical device module 101 is explained as having the shape of O-ring. A sectional view of the support member 103 having the shape of O-ring, viewed from +Z is shown in FIG. 3A. As shown in FIG. 3A, the support member 103 having the shape of O-ring is placed over 360 degrees along the outer circumference of the optical device module 101, and supports the optical device module 101. However, the present invention is not limited to this configuration. The support member 103 may be arbitrarily defined, and any name and any structure are possible as long as the optical connector 200 and the optical device module 101 are integrally swingable. For example, the support member 103 may have a C-shape as shown by the cross sectional view in FIG. 3B, which is viewed from +Z. As shown in FIG. 3C, the support member 103 may have an arrangement such as placing multiple (for example, four pieces) spherical objects on the outer circumference of the optical device module 101.

In the above embodiment, an explanation has been made using silicon rubber as a material of the support member 103. A characteristic of the silicon rubber is that its elasticity characteristics hardly change within the usage temperature range from −40° C. to 85° C., and its solid-state properties are stable. Material used for the support member 103 of the present invention is not limited to an elastic material such as silicon rubber, but may be arbitrarily decided. For example, the material of the support member 103 may include a material such as magnetic substance powder or the like, thereby providing the support member 103 with a property of radio wave absorption. With this configuration, unnecessary electromagnetic radiation can be suppressed. It is further possible to include a metallic powder in the material of the support member 103, thereby providing the support member 103 with conductivity. It is still further possible to include a material having a high thermal conductivity in the material of the support member 103. With the configuration above, heat generated in the optical device module 101 is conducted to the enclosure 102, and a rise of temperature in the optical device module 101 can be suppressed. As a further alternative, a material without any elasticity may be used for the support member 103.

Furthermore, in the above embodiment, it has been explained that the optical device module 101 includes both the light-emitting device 116 and the light-receiving device 117. However, it is alternatively possible that the optical device module 101 of the present invention includes only the light emitting device 116, or includes only the light receiving device 117.

In the above embodiment, an LC type optical connector is employed as the optical connector 200. However, the present invention is not limited to this configuration, and any type of optical connector may be available for the optical connector 200. For example, an MU type optical connector or an SC type optical connector may be used.

1. A receptacle type optical apparatus comprising,
an optical device module having at least either one of a light emitting device and a light receiving device, and
an enclosure that stores the optical device module,
the receptacle type optical apparatus allowing a part of an optical connector to be inserted inside the enclosure and establishing connection with the optical connector, wherein
an inner spatial area is formed in the enclosure that allows the part of the optical connector and the optical device module to be swingable with respect to a predetermined position of the optical device module, and
a support member is provided to swingably support the part of the optical connector and the optical device module integrally at the predetermined position.

2. The receptacle type optical apparatus according to claim 1, wherein
the optical device module comprises a ferrule in which an optical waveguide is formed, and the optical devices to receive light from the ferrule or to emit light to the ferrule, and
the ferrule and the optical devices are mutually connected such that mutual relative displacement with each other not possible.

3. The receptacle type optical apparatus according to claim 2, wherein
the predetermined position is a position of the ferrule in a direction along which the optical connector is inserted.

4. The receptacle type optical apparatus according to claim 1, wherein
the support member is an elastic member.

5. The receptacle type optical apparatus according to claim 1, wherein
the support member includes a material to absorb electromagnetic waves.

6. The receptacle type optical apparatus according to claim 1, wherein
the support member includes a thermal conductive material.

7. The receptacle type optical apparatus according to claim 1, wherein
the support member is placed on an outer circumference of the optical device module.

8. The receptacle type optical apparatus according to claim 1, wherein
the support member is an O-ring.

9. The receptacle type optical apparatus according to claim 7, wherein
the support member includes a conductive material.
